(19) United States
(12) Patent Application Publication
(10) Pub. No.: US 2026/0119258 A1
(43) Pub. Date: Apr. 30, 2026

(54) ELASTIC JOB PULLING FOR A SCHEDULING SYSTEM

(71) Applicant: SAP SE, Walldorf (DE)

(72) Inventor: Hao WENG, Shanghai (CN)

(21) Appl. No.: 18/925,224

(22) Filed: Oct. 24, 2024

(51) Int. Cl. G06F 9/50; G06F 9/48

(52) U.S. Cl. CPC G06F 9/5038; G06F 9/4881

(57) ABSTRACT

Disclosed herein are a system, method, and computer program product embodiments for elastic job pulling. For example, a first indication of a number of jobs at the job scheduler stage that are yet to be executed is obtained. This indication may be obtained from a job scheduler. A second indication of a total number of available job executors communicatively coupled to the job scheduler may be obtained from the job scheduler. A pull request for a job may be issued to the job scheduler based on at least one of the first indication, the second indication, or a computing resource status of a job executor. The job executor may obtain and execute the job based on the pull request. A status indication of the job may be transmitted, where the status indication indicates whether the job executed successfully.

### BACKGROUND

A job scheduling system is typically composed of two main components: a job scheduler and a job executor. The job scheduler schedules jobs for execution, while the job executor obtains the jobs from the job scheduler and executes the jobs. A job executor may obtain jobs from the job scheduler using two techniques. In the first technique, the job scheduler pushes jobs to the job executor. In the second technique, the job executor pulls jobs from job scheduler. Many job scheduling systems utilize the second technique due to the various challenges arising from the uncertainty of job execution time and the difficulty in collecting and maintaining the job execution capability of the job executor in real time. However, the second technique can result in too many unnecessary job pull requests (where job executors are issuing job pull requests, but the job scheduler does not have any jobs to forward). The second technique can also result in the job executors issuing job pull requests too slowly such that job executors’ resources are idle (e.g., not processing jobs). Both scenarios can occur when job executors pull jobs from the job scheduler using a fixed polling interval that is not aligned with the number of jobs or the utilization of computing resources.

### BRIEF DESCRIPTION OF THE DRAWINGS

The accompanying drawings are incorporated herein and form a part of the specification.

FIG. 1 shows a block diagram of a system configured to schedule and execute jobs, according to some embodiments.

FIG. 2 is a call flow diagram illustrating example communications between an application, a job scheduler, and a job executor, according to some embodiments.

FIG. 3 is a flowchart of a method for determining whether to pull a job from a job scheduler, according to some embodiments.

FIG. 4 is a flowchart of a method for elastic job pulling, according to some embodiments.

FIG. 5 is a flowchart of a method for determining to pull a job, according to some embodiments.

FIG. 6 is a flowchart of a method for determining to pull a job based on a number of times a job pull has been ignored, according to some embodiments.

FIG. 7 is a flowchart of a method determining to pull a job based on a random pull condition, according to some embodiments.

FIG. 8 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are a system, apparatus, device, method and/or computer program product embodiments, and/or combinations and sub-combinations thereof, for elastic job pulling. For example, a first indication of a number of jobs at the job scheduler stage that are yet to be executed is obtained. This indication may be obtained from a job scheduler. A second indication of a total number of available job executors communicatively coupled to the job scheduler may be obtained from the job scheduler. A pull request for a job may be issued to the job scheduler based on at least one of the first indication, the second indication, or a computing resource status of a job executor. The job executor may obtain and execute the job based on the pull request. A status indication of the job may be transmitted, where the status indication indicates whether the job executed successfully.

The techniques described herein improve the functioning of a computing system. For example, conventional techniques transmit pull requests from a plurality of job executors to a job scheduler in a periodic fashion (e.g., at expiration of a timer). This causes pull requests to be transmitted regardless of whether a job is scheduled and also ignores the amount of computing resources available for executing a job at the job executor (e.g., a very busy job executor pulls a job in front of another job executor that isn’t busy, and thus, the execution of the job is delayed until the busy job executor becomes less busy and can execute the job it pulled). In addition, with a plurality of job executors, a plurality of unnecessary pull requests are generated and sent to the job scheduler. As the computer system scales up to having an X number of job executors associated with one job scheduler (where X is any positive integer), there could be approximately X pull requests being sent to the job scheduler, where many of the transmitted pull requests will not result in a job being transmitted to a particular job executor. Taking this example to an extreme, in situations where there are no jobs waiting at the job scheduler, all X pull requests would be futile. This negatively affects the network bandwidth and the computing resources of such a computing system, especially where job schedulers and job executors are sharing the same network.

The embodiments described herein, however, selectively transmit pull requests based on various criteria (e.g., based a number of jobs to be executed at a given time, a total number of available job executors, a computing resource status of the job executor, etc.). Accordingly, pull requests are transmitted when jobs are available for execution and while the job executor has the resources to execute a job. By limiting pull requests in such a manner, the network bandwidth of the computing system on which the job scheduling system executes is reduced, along with the computing resources (e.g., processor cycles, memory, storage, etc.) of the computing system on which the job executor executes.

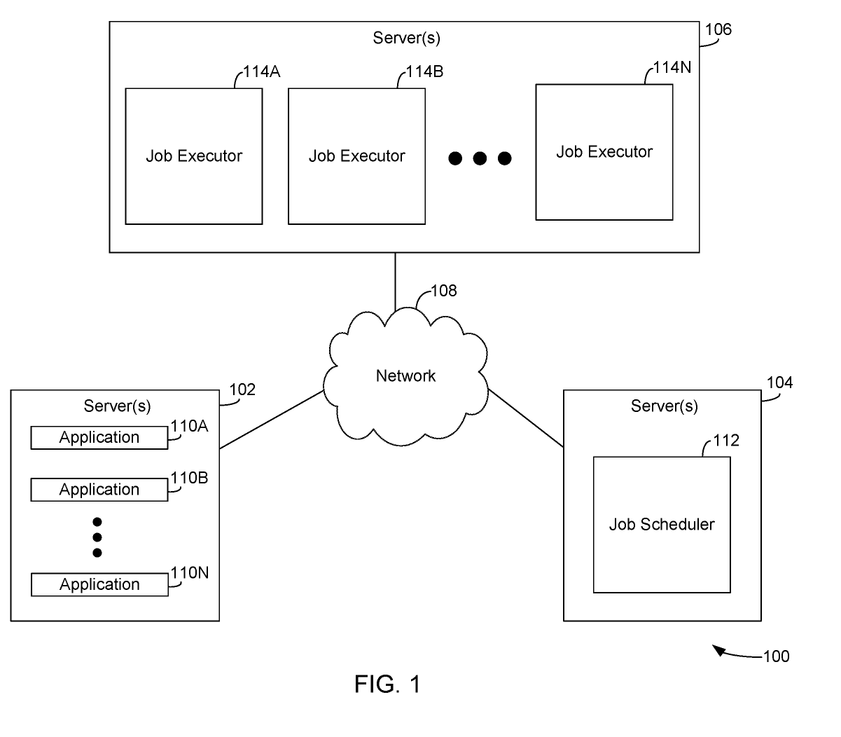

FIG. 1 shows a block diagram of a system 100 configured to schedule and execute jobs, according to some embodiments. As shown in FIG. 1, system 100 includes one or more servers 102, server(s) 104, and server(s) 106. Server(s) 102, 104, and 106 may be communicatively coupled to each other via a network 108. Network 108 may comprise one or more networks such as local area networks (LANs), wide area networks (WANs), enterprise networks, the Internet, etc., and may include one or more of wired and/or wireless portions.

In an embodiment, server(s) 102, 104, and 106 may form a network-accessible server set (e.g., a cloud-based environment or platform). Server(s) 102, 104, and 106 may be accessible via network 108 (e.g., in a “cloud-based” embodiment) to build, deploy, and manage applications and services. Server(s) 102, 104, and 106 may be co-located (e.g., housed in one or more nearby buildings with associated components such as backup power supplies, redundant data communications, environmental controls, etc.) to form a datacenter, or may be arranged in other manners. Accordingly, in an embodiment, server(s) 102, 104, and 106 may be a datacenter in a distributed collection of datacenters.

Each of server(s) 102, 104, and 106 may be configured to execute one or more software applications (or “applications”), services, or backend processes. For example, as shown in FIG. 1, server(s) 102 may be configured to execute applications 110A-110N. In one embodiment, one or more of applications 110A-110N are configured to execute core business processes for an entity (e.g., a business or enterprise). Such processes include, but are not limited to, finance and accounting, human resource management, source and procurement, sales, manufacturing, etc. Finance and accounting processes may capture customer transactions and manage customer accounts. Such transactions include, but are not limited to, accounts receivable-related and accounts payable-related transactions (e.g., invoice posting, credit memo posting, down payments, invoice payments, etc.), closing an entity’s books, generating financial reports, etc. Human resource management processes may generate attendance and payroll records. Sourcing and procurement processes may generates requests for quotes, generates contracts, etc. Sales processes may generates records pertaining to communications between the entity and customers (or potential customers), order management records, etc. Manufacturing processes may generate production scheduling records, quality management records, etc. Is it noted that one or more of applications 110A-110N may be configured to perform other types of functions and that the embodiments described herein are not limited to the functions described herein.

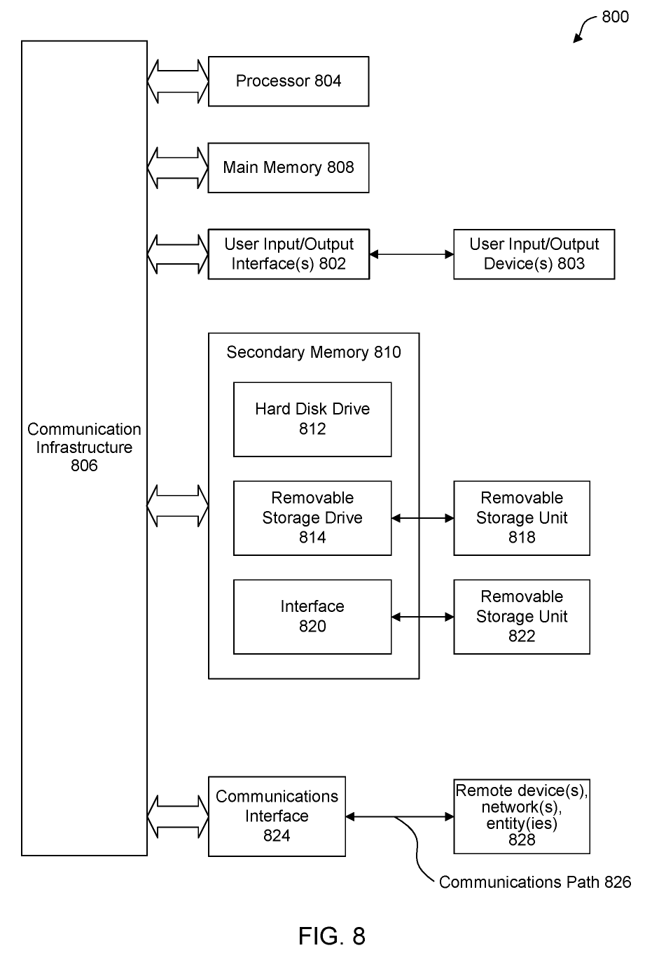

Server(s) 104 may be configured to execute a job scheduler 112. Job scheduler 112 may be implemented by processing logic that can comprise hardware (e.g., circuitry, dedicated logic, programmable logic, microcode, etc.), software (e.g., instructions executing on a processing device), or a combination thereof. In an embodiment, job scheduler 112 is implemented in one or more software processes executing on one or more processor-based computer systems, such as computer system 800 as described below in reference to FIG. 8.

Job scheduler 112 may be configured to schedule various jobs for applications 110A-110N. As used herein, a job may be an executable unit of work comprising one or more tasks. For instance, job scheduler 112 may schedule jobs to be performed at a predetermined time or responsive to a particular event occurring. Job scheduler 112 may comprise a data structure, such as a queue, for storing the jobs. Examples of jobs may include, but are not limited to, posting invoices, processing payments, generating records, etc.

Server(s) 106 may be configured to execute one or more job executors (e.g., job executors 114A-114N. Job executors 114A-114N may be implemented by processing logic that can comprise hardware (e.g., circuitry, dedicated logic, programmable logic, microcode, etc.), software (e.g., instructions executing on a processing device), or a combination thereof. In an embodiment, job executors 114A-114N are implemented in one or more software processes executing on one or more processor-based computer systems, such as computer system 800 as described below in reference to FIG. 8.

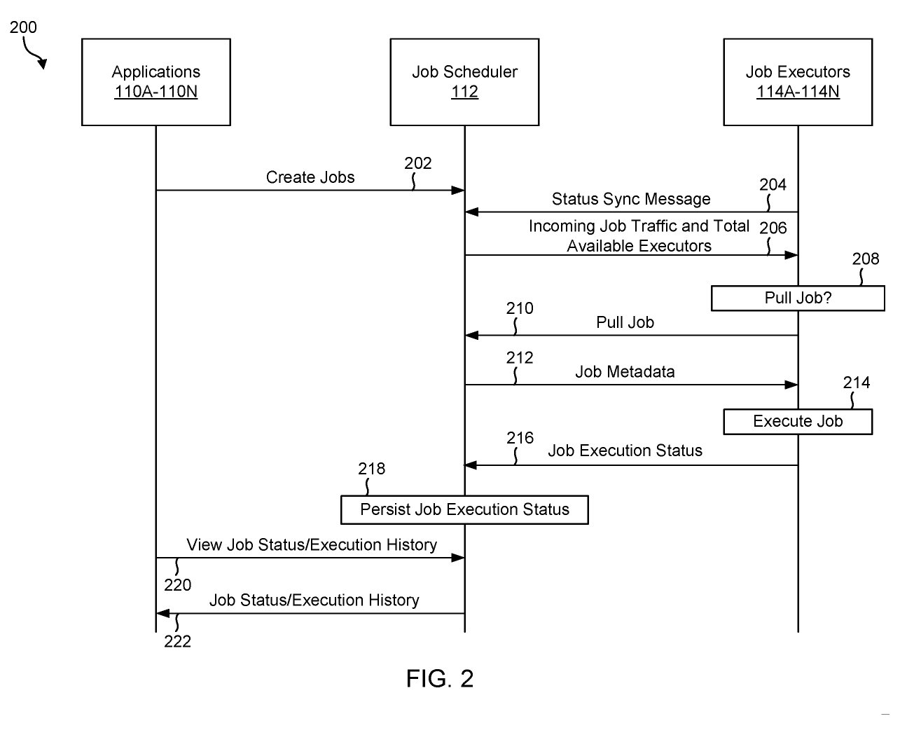

Each of job executors 114A-114N may be configured to pull jobs from job scheduler 112 (e.g., from a queue of job scheduler 112) at a variable rate (i.e., jobs are not pulled in a strictly periodic fashion). Such a pulling scheme may be referred herein as an elastic pulling scheme. As used herein, job pulling refers to a particular job executor of job executors 114A-114N determining when to obtain a job from job scheduler 112 rather than having job scheduler 112 push a job to a particular job executor of job executors 114A-114N (e.g., where job scheduler 112 determines when to provide a job to a particular job executor). Each of job executors 114A-114N may be configured to execute a plurality of threads (also referred herein as a “worker thread”), each configured to execute a particular job once a job is pulled from job scheduler 112. Each of the threads may be configured to be executed in parallel so that multiple jobs may be executed in parallel. Each of job executors 114A-114N may be configured to pull jobs based on various criteria including, but not limited to, job traffic, job execution capability of the job executor, and a total number of available job executors 114A-114N. The job execution capability may be based on a utilization (e.g., by job executors 114A-114N) of resources of server(s) 106. Additional details regarding job scheduler 112 and job executors 114A-114N are provided below with reference to FIGS. 2-7. It is noted that while FIG. 1 depicts applications 110A-110N, job scheduler 112, and job executors 114A-114N as executing on different server(s) 102, 104, and 106, respectively, it is noted that the embodiments described herein are not so limited. For instance, in some embodiments, applications 110A-110N, job scheduler 112, and/or job executors 114A-114N may execute on the same computing device.

FIG. 2 is a call flow diagram 200 illustrating example communications between applications 110A-110N, job scheduler 112, and job executors 114A-114N, according to some embodiments. As shown in FIG. 2, at 202, each of applications 110A-110N may create one or more jobs and provide such job(s) to job scheduler 112. Job scheduler 112 may store the job(s) in a data structure, such as a queue.

At 204, each of job executor 114A-114N may periodically provide a status synchronization message to job scheduler 112. The status synchronization message may include status information associated with its corresponding job executor. The status information may include an indication that its corresponding job executor 114 is available for executing jobs, an indication of the jobs currently being executed, an indication of the jobs that were successfully executed, and/or an indication of the jobs that were unsuccessfully executed. It is noted that each of job executors 114A-114N in the system may provide such status information to job scheduler 112. This way, job scheduler 112 may determine the total number of job executors that are available for job execution. The status synchronization message may also include a request for status information from job scheduler 112, such as jobs in job scheduler 112 that are waiting to be pulled and executed.

At 206, responsive to the status synchronization message(s) received at 204, job scheduler 112 may provide status information associated with job scheduler 112 to the job executors that provided the status synchronization messages (e.g., job executors 114A-114N). Such status information may include an indication of incoming job traffic, an indication of the total number of available job executors and data indicating which, if any, jobs in job scheduler 112 are on-demand jobs. The indication of the incoming job traffic may indicate a number of jobs to be executed for one or more of applications 110A-110N (e.g., the number of jobs stored in the data structure maintained by job scheduler 112 that will eventually be sent to one or more of job executers 114A-114N (e.g., incoming from the perspective of the job executor(s)). The jobs to be executed may include jobs that are scheduled to be executed within a predetermined time period (e.g., a future job) and on-demand jobs (e.g., jobs that have been designated, e.g., by one or more of applications 110A-110N, to be executed as soon as possible or immediately). It is noted that the exchange of status information between job scheduler 112 and job executors 114A-114N at 204 and 206 occur periodically (e.g., once every second, minute, every 5 minutes, every hour, etc.). It is further noted that the periodic status synchronization message provided by job executors 114A-114N may be referred to as a heartbeat signal.

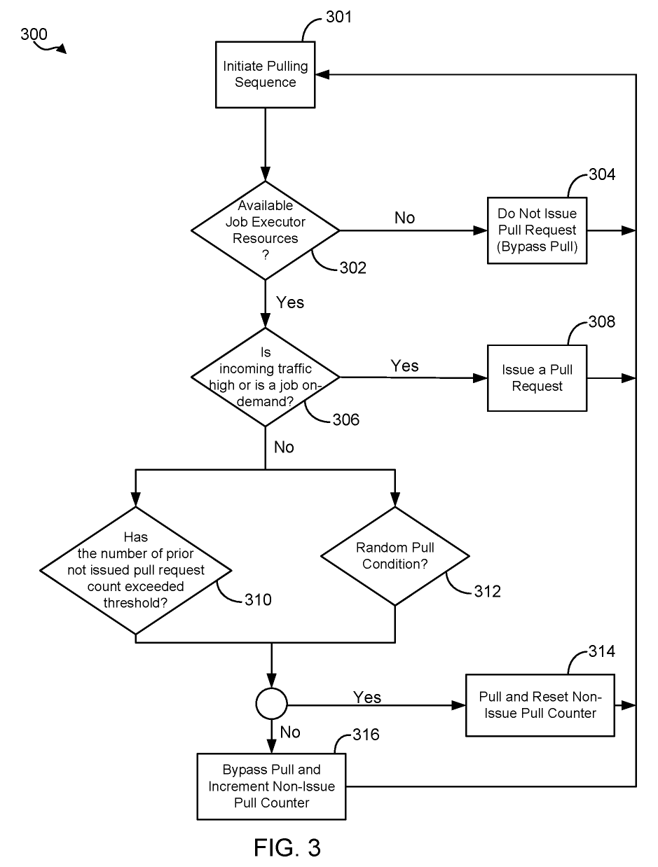

At 208, one or more of job executors 114A-114N may determine whether to pull a job from job scheduler 112. Each of job executors 114A-114N may base the determination as to whether to pull a job based on the indication of incoming job traffic provided by job scheduler 112 at 206, the indication of the total available number of available job executors provided by job scheduler 112 at 206, and/or the job execution capability of the job executor. The job execution capability of each of job executors 114A-114N (e.g., the capability for job executors 114A-114N to execute a job) may be based on the processing resource status of job executors 114A-114N. For instance, each of job executors 114A-114N may comprise one or more performance trackers or counters that track various computer resources allocated for and/or by the job executor. Such tracker(s) or counter(s) may track the storage utilization of the job executor, the memory utilization of the job executor, processor (e.g., central processing unit (CPU) utilization of the job executor, the number of available worker threads for the job executor 114, etc. Each of job executors may assess the incoming job traffic, the total available number of available job executors, and/or the job execution capability of the job executor in a periodic fashion (e.g., every 1 minute, 5 minutes, etc.). Additional details regarding determining whether to pull a job are provided below with reference to FIG. 3.

At 210, in response to determining that a job is to be pulled, job executors 114A-114N may pull a job from job scheduler 112.

At 212, in response to one or more of job executors 114A-114N pulling a job from job scheduler 112, job scheduler 112 may provide metadata associated with the pulled job to such job executor(s). The metadata may include, among other things, an indication of when the pulled job is it be executed (e.g., a date and/or time) or whether the pulled job is an on-demand job (e.g., an indication that the job is to be executed immediately or as soon as possible).

At 214, job executors 114A-114N executes respective jobs, and at 216, returns a job execution status to job scheduler 112. The job execution status may indicate that the execution of the respective job was successful, failed, or pending.

At 218, job scheduler 112 may persist (e.g., store) the job execution status received at 216.

At 220, each of applications 110A-110N may provide a request to job scheduler 112 for the job execution status of the jobs it created (e.g., created at 202) and/or an execution history of the jobs (e.g., a listing of whether execution of previous jobs was successful or failed). At 222, responsive to the request received at 220, job scheduler 112 may provide the job execution status of the jobs and/or the execution history of the jobs to the requesting applications (e.g., one or more of applications 110A-110N. As described above, the job execution status returned to the requesting applications may indicate whether jobs created at 202 executed successfully, failed, or are still pending.

FIG. 3 is a flowchart of a method 300 for determining whether to pull a job from a job scheduler, according to some embodiments. Method 300 may be an example of the operations described above with reference to 208 of FIG. 2. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art. It is noted that FIG. 3 is described with reference to one job executor (referred to as job executor 114). However, it is noted that each of job executors 114A-114N may be configured to perform method 300.

Method 300 shall be described with reference to FIG. 2. However, method 300 is not limited to that example embodiment.

In 301, job executor 114 may initiate an elastic pulling sequence. For example, job executor 114 may initiate the elastic pulling sequence in a periodic fashion (e.g., every 1 minute, 5 minutes, etc.).

In 302, job executor 114 may determine whether job executor 114 has available computing resources to pull and/or execute a job based on the processing resource status of job executor 114. For example, job executor 114 may determine whether job executor 114 has an available worker thread to execute a job (e.g., has at least one available worker thread) and/or determine whether its compute resource utilization (e.g., CPU, memory, and/or storage) meets a predetermined threshold. In one example, job executor 114 may determine an amount of available computing resources (e.g., the available percentage of compute resources) based on the computing resource utilization and determine whether the available percentages of such computing resources are below a predetermined percentage (e.g., 10%). In response to determining that there are no available worker threads and/or the computing resource utilization is below the predetermined percentage, flow continues to 304. Otherwise, flow continues to 306.

At 304, job executor 114 may not issue a pull request to job scheduler 112, and flow returns to 301. For example, job executor 114 may bypass the issuance of a pull request.

At 306, job executor 114 may determine whether the number of jobs in jobs scheduler 112 meets or exceeds a predetermined threshold (e.g., there is a pending high level of incoming traffic) or whether a job (e.g., the next job in the queue) is an on-demand job. Job executor 114 may determine the number of jobs to be executed and/or whether a job is an on-demand job based on the indication provided to job executor 114 at 206. If job executor 114 determines that the number of jobs to be executed exceeds a threshold or whether a job is an on-demand job, flow continues to 308. Otherwise, flow continues to 310 and 312.

At 308, job executor 114 may issue a pull request for a job to job scheduler 112 (e.g., at 210), and flow returns to 301.

At 310, job executor 114 may determine whether a number of prior not issued pull requests (e.g., the number of pull requests that were bypassed) meets (e.g., reaches or exceeds) a predetermined threshold. That is, job executor 114 may determine that is has not issued a pull request after having gone through portions of the flow represented in FIG. 3 multiple times (e.g., steps 302 and 304). In an embodiment, job executor 114 may maintain a counter (e.g., a non-issue pull counter) that tracks the number of times job executor 114 did not issue a pull request.

One benefit, among others, of not exceeding a certain number of non-issued pull requests is to maintain sufficient throughput of the job scheduling and executing process. That is, if too many or even all of the job executors 114A-114N do not issue pull requests often enough, a backlog of jobs could develop in the job scheduler 112 and decrease the overall efficiency of the system. There are a plurality of ways to set the threshold for non-issued pull requests. In one such embodiment, this threshold is equal to the total number of available job executors, where the availability itself can be determined by either the total number of job executors 114A-114N assigned to job scheduler 112 by the system administrator or where availability is determined by job executors 114A-114N being underutilized at a particular time. Such information may be determined via the status sync message sent from job scheduler 112 to job executors 114A-114N at 206 in FIG. 2, where job scheduler 112 compiles the utilization information from the plurality of job executors 114A-114N via message 204.

At 312, job executor 114 may generate a random number and determine whether a random pull condition has been met. For instance, job executor 114 may comprise a random number generator configured to generate a random number. The random number generator may generate the random number periodically, at the start of the elastic pull sequence (e.g., at step 301), or after a determination that the number of jobs in jobs scheduler 112 does not exceed a predetermined threshold or that a job (e.g., the next job in the queue) is not an on-demand job (as determined at step 306). The random number may have an upper bound equal to the total number of available job executors. Accordingly, the random number generator may generate a number between 1 and the total number of available job executors. Job executor 114 may compare the randomly-generated number to a predetermined value (e.g., 1). If the randomly-generated number equals the predetermined value, then job executor 114 determines that the random pull condition has been met and pulls a job from job scheduler (e.g., at 210). In an example in which the total number of available job executors is 10, a random pull would occur 10% of the time. By performing a pull in a random fashion, jobs may be sporadically pulled from job scheduler 112 even in instances where job traffic is relatively low. This ensures that jobs scheduled by job scheduler 112 are eventually pulled and executed.

In response to determining that the number of non-issued job pull requests meet the predetermined threshold and/or the random pull condition has been met, flow continues to 314. Otherwise, flow continues to 316.

At 314, job executor 114 may pull a job from job scheduler 112 (e.g., at 210) and reset the non-issue pull request counter. Flow may then continue to 301.

At 316, job executor 114 may not issue the pull request and increment the non-issue pull counter. Flow may then continue to 301.

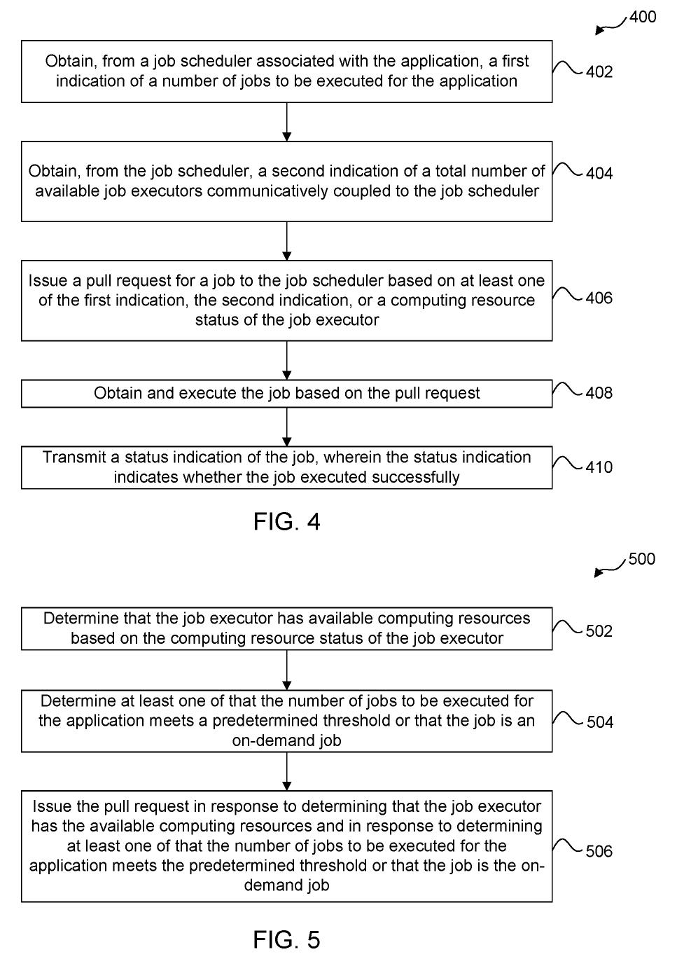

FIG. 4 is a flowchart of a method 400 for elastic job pulling, according to some embodiments. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art. It is noted that FIG. 4 is described with reference to one job executor (referred to as job executor 114). However, it is noted that each of job executors 114A-114N may be configured to perform method 400.

Method 400 shall be described with reference to FIG. 2. However, method 400 is not limited to that example embodiment.

In 402, job executor 114 may obtain, from job scheduler 112 associated with application 110, a first indication of a number of jobs to be executed for the application (e.g., at 206).

In 404, job executor 114 may obtain, from job scheduler 112, a second indication of a total number of available job executors 114 communicatively coupled to job scheduler 112 (e.g., at 206).

In 406, job executor 114 may issue (e.g., at 210) a pull request for a job to job scheduler 112 based on at least one of the first indication, the second indication, or a computing resource status of the job executor 114. In some embodiments, the computing resource status comprises at least one of storage utilization of job executor 114, memory utilization of job executor 114, or processor utilization of job executor 114.

In 408, job executor 114 may obtain and execute (e.g., at 214) the job based the pull request.

In 410, job executor 114 may transmit (e.g., at 216) a status indication of the job, wherein the status indication indicates whether the job executed successfully.

FIG. 5 is a flowchart of a method 500 for determining to pull a job, according to some embodiments. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art. It is noted that FIG. 5 is described with reference to one job executor (referred to as job executor 114). However, it is noted that each of job executors 114A-114N may be configured to perform method 500.

Method 500 shall be described with reference to FIG. 2. However, method 500 is not limited to that example embodiment.

In 502, job executor 114 may determine (e.g., at 208) that job executor 114 has available computing resources based on the computing resource status of job executor 114.

In 504, job executor 114 may determine (e.g., at 208) at least one of that the number of jobs to be executed for application 110 meets a predetermined threshold or that the job is an on-demand job.

In 506, job executor 114 may issue (e.g., at 210) the pull request in response to determining at least one of that the number of jobs to be executed for application 110 meets the predetermined threshold or that the job is the on-demand job.

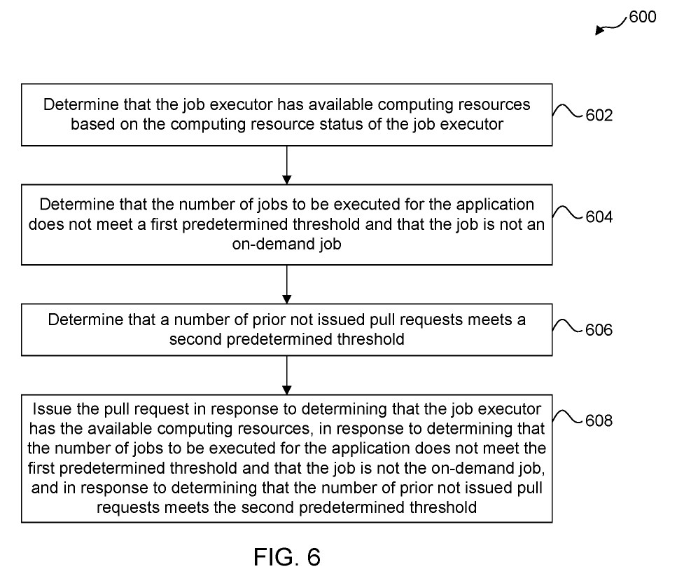

FIG. 6 is a flowchart of a method 600 for determining to pull a job based on a number of times a job pull has been ignored, according to some embodiments. Method 600 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 6, as will be understood by a person of ordinary skill in the art. It is noted that FIG. 6 is described with reference to one job executor (referred to as job executor 114). However, it is noted that each of job executors 114A-114N may be configured to perform method 600.

Method 600 shall be described with reference to FIG. 2. However, method 600 is not limited to that example embodiment.

In 602, job executor 114 may determine (e.g., at 208) that job executor 114 has available computing resources based on the computing resource status of job executor 114.

In 604, job executor 114 may determine (e.g., at 208) that the number of jobs to be executed for application 110 does not meet a first predetermined threshold and that the job is not an on-demand job.

In 606, job executor 114 may determine (e.g., at 208) that a number of prior not issued pull requests meets a second predetermined threshold. In some embodiments, the second predetermined threshold is based on the total number of available job executors 114.

In 608, job executor 114 may issue (e.g., at 210) the pull request in response to determining that job executor 114 has the available computing resources, in response to determining that the number of jobs to be executed for application 110 does not meet the first predetermined threshold and that the job is not the on-demand job, and in response to determining that the number of prior not issued pull requests meets the second predetermined threshold.

In some embodiments, job executor 114 may reset the number of prior not issued pull requests in response to determining that the number of jobs to be executed for application 110 does not meet the first predetermined threshold, and in response to determining that the number of prior not issued pull requests is less than the total number of available job executors.

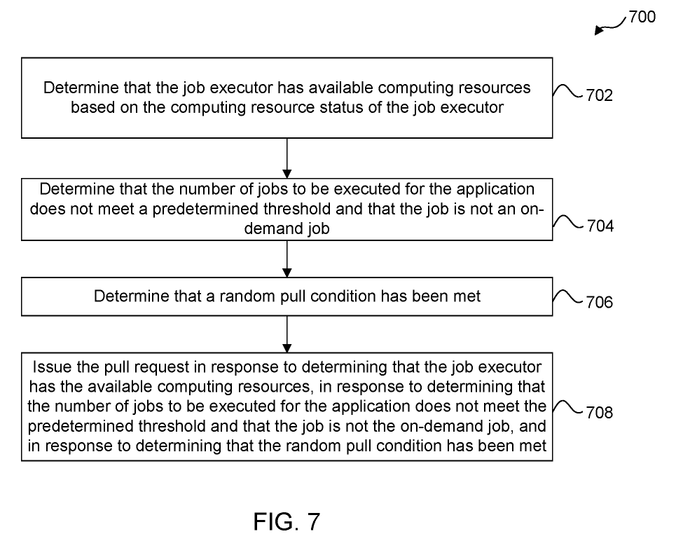

FIG. 7 is a flowchart of a method 700 for determining to pull a job based on a random pull condition, according to some embodiments. Method 700 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 7, as will be understood by a person of ordinary skill in the art. It is noted that FIG. 7 is described with reference to one job executor (referred to as job executor 114). However, it is noted that each of job executors 114A-114N may be configured to perform method 700.

Method 700 shall be described with reference to FIG. 2. However, method 700 is not limited to that example embodiment.

In 702, job executor 114 may determine (e.g., at 208) that job executor 114 has available computing resources based on the computing resource status of job executor 114.

In 704, job executor 114 may determine (e.g., at 208) that the number of jobs to be executed for application 110 does not meet a predetermined threshold and that the job is not an on-demand job.

In 706, job executor 114 may determine (e.g., at 208) that a random pull condition has been met.

In 708, job executor 114 may issue (e.g., at 210) the pull request in response to determining that job executor 114 has the available computing resources, in response to determining that the number of jobs to be executed for application 110 does not meet the predetermined threshold and that the job is not the on-demand job, and in response to determining that the random pull condition has been met.

In some embodiments, the random pull condition is based on a randomly-generated value equaling a predetermined value, and the randomly-generated value is based on the total number of available job executors 114.

Various embodiments may be implemented, for example, using one or more well-known computer systems, such as computer system 800 shown in FIG. 8. One or more computer systems 800 may be used, for example, to implement any of the embodiments discussed herein, as well as combinations and sub-combinations thereof.

Computer system 800 may include one or more processors (also called central processing units, or CPUs), such as a processor 804. Processor 804 may be connected to a communication infrastructure or bus 806.

Computer system 800 may also include user input/output device(s) 803, such as monitors, keyboards, pointing devices, etc., which may communicate with communication infrastructure 806 through user input/output interface(s) 802.

One or more of processors 804 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 800 may also include a main or primary memory 808, such as random access memory (RAM). Main memory 808 may include one or more levels of cache. Main memory 808 may have stored therein control logic (i.e., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 may include a computer usable or readable storage device having stored thereon computer software (control logic) and/or data. Removable storage unit 818 may be a floppy disk, magnetic tape, compact disk, DVD, optical storage disk, and/ any other computer data storage device. Removable storage drive 814 may read from and/or write to removable storage unit 818.

Secondary memory 810 may include other means, devices, components, instrumentalities or other approaches for allowing computer programs and/or other instructions and/or data to be accessed by computer system 800. Such means, devices, components, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include a communication or network interface 824. Communication interface 824 may enable computer system 800 to communicate and interact with any combination of external devices, external networks, external entities, etc. (individually and collectively referenced by reference number 828). For example, communication interface 824 may allow computer system 800 to communicate with external or remote devices 828 over communications path 826, which may be wired and/or wireless (or a combination thereof), and which may include any combination of LANs, WANs, the Internet, etc. Control logic and/or data may be transmitted to and from computer system 800 via communication path 826.

Computer system 800 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 800 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 800 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 800, main memory 808, secondary memory 810, and removable storage units 818 and 822, as well as tangible articles of manufacture embodying any combination of the foregoing. Such control logic, when executed by one or more data processing devices (such as computer system 800), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 8. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method implemented by a job executor associated with an application, comprising:
obtaining, from a job scheduler associated with the application, a first indication of a number of jobs to be executed for the application;
obtaining, from the job scheduler, a second indication of a total number of available job executors communicatively coupled to the job scheduler;
issuing a pull request for a job to the job scheduler based on at least one of the first indication, the second indication, or a computing resource status of the job executor;
obtaining and executing the job based on the pull request; and
transmitting a status indication of the job, wherein the status indication indicates whether the job executed successfully.

2. The method of claim 1, wherein issuing the pull request based on at least one of the first indication, the second indication, or the computing resource status of the job executor comprises:
determining that the job executor has available computing resources based on the computing resource status of the job executor;
determining at least one of that the number of jobs to be executed for the application meets a predetermined threshold or that the job is an on-demand job; and
issuing the pull request in response to determining that the job executor has the available computing resources and in response to determining at least one of that the number of jobs to be executed for the application meets the predetermined threshold or that the job is the on-demand job.

3. The method of claim 1, wherein issuing the pull request based on at least one of the first indication, the second indication, or the computing resource status of the job executor comprises:
determining that the job executor has available computing resources based on the computing resource status of the job executor;
determining that the number of jobs to be executed for the application does not meet a first predetermined threshold and that the job is not an on-demand job;
determining that a number of prior not issued pull requests meets a second predetermined threshold; and
issuing the pull request in response to determining that the job executor has the available computing resources, in response to determining that the number of jobs to be executed for the application does not meet the first predetermined threshold and that the job is not the on-demand job, and in response to determining that the number of prior not issued pull requests meets the second predetermined threshold.

4. The method of claim 3, wherein the second predetermined threshold is based on the total number of available job executors.

5. The method of claim 3, further comprising:
resetting the number of prior not issued pull requests in response to determining that the number of jobs to be executed for the application does not meet the first predetermined threshold, and in response to determining that the number of prior not issued pull requests is less than the total number of available job executors.

6. The method of claim 1, wherein issuing the pull request based on at least one of the first indication, the second indication, or the computing resource status of the job executor comprises:
determining that the job executor has available computing resources based on the computing resource status of the job executor;
determining that the number of jobs to be executed for the application does not meet a predetermined threshold and that the job is not an on-demand job;
determining that a random pull condition has been met; and
issuing the pull request in response to determining that the job executor has the available computing resources, in response to determining that the number of jobs to be executed for the application does not meet the predetermined threshold and that the job is not the on-demand job, and in response to determining that the random pull condition has been met.

7. The method of claim 6, wherein the random pull condition is based on a randomly-generated value equaling a predetermined value, and wherein the randomly-generated value is based on the total number of available job executors.

8. The method of claim 1, wherein the computing resource status of the job executor comprises at least one of:
storage utilization of the job executor;
memory utilization of the job executor; or
processor utilization of the job executor.

9. A system, comprising:
a memory; and
at least one processor coupled to the memory and configured to:
obtain, from a job scheduler associated with an application, a first indication of a number of jobs to be executed for the application;
obtain, from the job scheduler, a second indication of a total number of available job executors communicatively coupled to the job scheduler;
issue a pull request for a job to the job scheduler based on at least one of the first indication, the second indication, or a computing resource status of the job executor;
obtain and execute, by the job executor, the job based on the pull request; and
transmit a status indication of the job, wherein the status indication indicates whether the job executed successfully.

10. The system of claim 9, wherein, to issue the pull request based on at least one of the first indication, the second indication, or the computing resource status of the job executor, the at least one processor is configured to:
determine that the job executor has available computing resources based on the computing resource status of the job executor;
determine at least one of that the number of jobs to be executed for the application meets a predetermined threshold or that the job is an on-demand job; and
issue the pull request in response to determining that the job executor has the available computing resources and in response to determining at least one of that the number of jobs to be executed for the application meets the predetermined threshold or that the job is the on-demand job.

11. The system of claim 9, wherein, to issue the pull request based on at least one of the first indication, the second indication, or the computing resource status of the job executor, the at least one processor is configured to:
determine that the job executor has available computing resources based on the computing resource status of the job executor;
determine that the number of jobs to be executed for the application does not meet a first predetermined threshold and that the job is not an on-demand job;
determine that a number of prior not issued pull requests meets a second predetermined threshold; and
issue the pull request in response to determining that the job executor has the available computing resources, in response to determining that the number of jobs to be executed for the application does not meet the first predetermined threshold and that the job is not the on-demand job, and in response to determining that the number of prior not issued pull requests meets the second predetermined threshold.

12. The system of claim 11, wherein the second predetermined threshold is based on the total number of available job executors.

13. The system of claim 11, wherein the at least one processor is further configured to:
reset the number of prior not issued pull requests in response to determining that the number of jobs to be executed for the application does not meet the first predetermined threshold, and in response to determining that the number of prior not issued pull requests is less than the total number of available job executors.

14. The system of claim 9, wherein, to issue the pull request based on at least one of the first indication, the second indication, or the computing resource status of the job executor, the at least one processor is configured to:
determine that the job executor has available computing resources based on the computing resource status of the job executor;
determine that the number of jobs to be executed for the application does not meet a predetermined threshold and that the job is not an on-demand job;
determine that a random pull condition has been met; and
issue the pull request in response to a determination that the job executor has the available computing resources, in response to a determination that the number of jobs to be executed for the application does not meet the predetermined threshold and that the job is not the on-demand job, and in response to a determination that the random pull condition has been met.

15. The system of claim 14, wherein the random pull condition is based on a randomly-generated value equaling a predetermined value, and wherein the randomly-generated value is based on the total number of available job executors.

16. The system of claim 9, wherein the computing resource status of the job executor comprises at least one of:
storage utilization of the job executor;
memory utilization of the job executor; or
processor utilization of the job executor.

17. A non-transitory computer-readable device having instructions stored thereon that, when executed by at least one computing device, cause the at least one computing device to perform operations, the operations comprising:
obtaining, from a job scheduler associated with an application, a first indication of a number of jobs to be executed for the application;
obtaining, from the job scheduler, a second indication of a total number of available job executors communicatively coupled to the job scheduler;
issuing, by a job executor, a pull request for a job to the job scheduler based on at least one of the first indication, the second indication, or a computing resource status of the job executor;
obtain and execute, by the job executor, the job based on the pull request; and
transmit, by the job executor, a status indication of the job, wherein the status indication indicates whether the job executed successfully.

18. The non-transitory computer-readable device of claim 17, wherein issuing the pull request based on at least one of the first indication, the second indication, or the computing resource status of the job executor comprises:
determining that the job executor has available computing resources based on the computing resource status of the job executor;
determining at least one of that the number of jobs to be executed for the application meets a predetermined threshold or that the job is an on-demand job; and
issuing the pull request in response to determining that the job executor has the available computing resources and in response to determining at least one of that the number of jobs to be executed for the application meets the predetermined threshold or that the job is the on-demand job.

19. The non-transitory computer-readable device of claim 17, wherein issuing the pull request based on at least one of the first indication, the second indication, or the computing resource status of the job executor comprises:
determining that the job executor has available computing resources based on the computing resource status of the job executor;
determining that the number of jobs to be executed for the application does not meet a first predetermined threshold and that the job is not an on-demand job;
determining that a number of prior not issued pull requests meets a second predetermined threshold; and
issuing the pull request in response to determining that the job executor has the available computing resources, in response to determining that the number of jobs to be executed for the application does not meet the first predetermined threshold and that the job is not the on-demand job, and in response to determining that the number of prior not issued pull requests meets the second predetermined threshold.

20. The non-transitory computer-readable device of claim 19, wherein the second predetermined threshold is based on the total number of available job executors.
